(19) United States
(12) Patent Application Publication
(10) Pub. No.: US 2010/0309821 A1
(43) Pub. Date: Dec. 9, 2010

(54) METHOD AND NETWORK FOR COMBINED PROTECTION OF ETHERNET TRAFFIC

(75) Inventor: Andrew SERGEEV, Kfar Sava (IL)

Correspondence Address: BROWDY AND NEIMARK, P.L.L.C.;624 NINTH STREET, NW, SUITE 300, WASHINGTON, DC, 20001-5303, US

(73) Assignee: ECI TELECOM, LTD., Petach-Tikva (IL)

(21) Appl. No.: 12/779,528

(22) Filed: May 13, 2010

(30) Foreign Application Priority Data
Jun. 4, 2009 (IL) 199146

(51) Int. Cl. H04L 12/28; H04L 29/02

(52) U.S. Cl. 370/256; 370/466

(57) ABSTRACT

Technique for protecting different telecommunication services in an Ethernet network using two different loop avoiding traffic protection protocols, by concurrently utilizing the protocols in one and the same network on different loop free logical topologies of the network. The telecommunication services are preliminarily distributed in such a manner, that the services which can be better protected by one of the two protocols and the services better protectable by the other protocol, are carried via the different topologies.

### FIELD OF THE INVENTION

The invention relates to a method of combined protection of traffic in various Ethernet networks (such as mesh networks, mixed-type networks, ring networks, for example metro Ethernet networks, Provider Bridge (PB) networks etc.), and to a network, a network node and a software product implementing such a combined protection. The invention is most efficient for metro Ethernet where bandwidth balancing is critical.

### BACKGROUND OF THE INVENTION

The Ethernet Ring Protection Protocol (ERPP) is a network protection mechanism for Ethernet ring topologies. In a network operating ERPP, one of the ports of one of the nodes in the ring is blocked in order to keep the ring open to avoid unwanted loops. If a link failure is detected in the ring, the previously blocked port is unblocked so that an alternative ring path becomes available.

The Spanning Tree Protocol (STP) is a network protection mechanism that provides path redundancy while preventing undesirable loops in a network. STP is defined by IEEE in standard 802.1. To provide path redundancy, STP defines a tree that spans all switches in an extended network. STP places certain redundant data paths into a standby state by blocking traffic in certain ports. If one network segment becomes unreachable, the STP reconfigures the spanning tree topology and re-establishes the link by activating a standby path. All nodes in a Local Area Network (LAN) participating in STP obtain information on other nodes in the network through an exchange of data messages (or, to be more accurate, signaling messages) known as bridge protocol data units (BPDUs).

In metro networks, where ring topologies are common, ERP is an attractive option because after detection of a link failure, ERP assures a 50 ms recovery time. In a ring STP assures a recovery time of 2 s. ERP has the drawback of being applicable only to single ring networks. In more complex networks that have mixed topologies of meshes and rings, ERP cannot be used alone but must be used with STP. ERP and STP are protocols that operate in the same network layer (OSI layer-2) and both avoid loops by blocking traffic in certain ports. For this reason, it is not possible to combine the two protocols in the same equipment. This makes it difficult for network operators to incorporate in networks running STP, equipment manufactured to run ERP and hence benefit from ERP's short ring protection time.

As STP and its variants do not run over ERP, there were attempts to integrate STP and ERP equipment so that to disable STP in all ports of a switch running ERP and to transport STP BPDUs transparently over the ERP ring. This approach results in STP aware equipment regarding ERP rings as being Local Area Networks. However, the described attempt to obtain a double-protected network is too complex and expensive.

To allow coexistence of two types of loop preventing protocols in a communication network, US 2008/0279203 A1 proposes to operate a node in a communications network so that two procedures are run at the same node: a first loop avoidance protocol and a protocol adaptation process that enables the first loop avoidance protocol to run over a second loop avoidance protocol operating in the network. The protocol adaptation comprises accepting STP BPDUs over ERP ports. According to that solution, the ERP protection events are “hidden” from the STP maintaining the same logical topology, i.e. ERP is adapted to STP.

US 2009/0022069 discusses interoperability of two loop preventing protocols running on different devices respectively. US 2009/0022069 does not discuss utilizing the two protocols within one and the same network for different services.

Further developments of the Spanning Tree Protocol result in a Rapid Spanning Tree Protocol (RSTP IEEE 802.Iw) and in a Multiple Spanning Tree Protocol (MSTP IEEE 802.1s) that creates multiple spanning trees configurations (instances) and thus allows efficient bandwidth (BW) balancing.

Further developments of the ERP have resulted in the standard recommendation G.8032 which is intended for very fast restoration in ring-like Ethernet networks.

In modern Metro Ethernet networks BW efficiency has the same importance as the protection efficiency.

Typical Carrier Ethernet network deployments may use MSTP protocol for efficient service delivery. This protocol allows to handle several logical loop-free topologies and to associate specific service (VLAN) group to different STP instances (different loop-free trees of the multiple spanning tree structure). Those STP instances perform blocking of some physical ports for specific VLANs, while perform forwarding of traffic of other VLANs. Owing to that, in MSTP there is no such a physical link which is blocked for traffic of all services. The protection (restoration) time could be in the range 200˜2000 ms depending on the number of nodes in an STP instance.

On the other hand, G.8032 protocol gives very fast protection for ring topology (sub 50 ms) however does not support the concept of multiple logical topologies—i.e. one link in the ring protected by G.8032 will be always blocked for any service traffic.

There is also an MPLS option for building CE (Carrier Ethernet networks), but some customers prefer to build non-MPLS based CE since it is complex and/or expensive. Presently, there is no such a possibility to combine the MSTP and G.8032 protocols in Ethernet networks which would allow benefiting from both of their advantages. Today, the most developed Ethernet traffic protection techniques allow reaching either the effective bandwidth balancing owing to MSTP, or the fast restoration in a ring network owing to G.8032, but do not allow judicially combining the protocols and the advantages.

### SUMMARY OF THE INVENTION

The above drawback can be overcome by utilizing the following novel technology proposed by the Inventor.

The Inventor provides a method for protecting different telecommunication services in an Ethernet network using at least two different loop avoiding traffic protection protocols, by concurrently utilizing said two protocols in one and the same network but on different logical topologies of the network, wherein said telecommunication services are preliminarily distributed in such a manner, that the services which can be appropriately (better) protected by one of the two protocols and the services which can be better protected by the other of the two protocols are respectively carried via different logical topologies.

Said different logical topologies should be understood as topologies which are to be loop-free, and they actually are loop free topologies (either before or after applying said loop avoiding traffic protection protocols). These topologies will therefore be called either logical topologies, or loop free logical topologies.

More specifically, the method comprises the following steps:
grouping said services into at least two groups, wherein one group comprises services appropriately protectable by one of the two protocols, and the other group comprises services appropriately protectable by the other of the two protocols;
creating in said network two or more loop-free logical topologies (instances);
assigning said services to said topologies so that one topology carries services belonging to one and the same group;
associating said two or more topologies with said two protocols so that each of the protocols is associated with at least one topology, and services assigned to a specific topology are appropriately protected by the protocol associated with said specific topology;
providing traffic protection in said network by applying said two protocols, on their respectively associated topologies, so that two types of protection according to the two different protocols can be provided concurrently and independently from one another,
   thereby ensuring for each of said two groups of telecommunication services optimal protection in the network.

It should be understood that since the two protection protocols are to be utilized in the one and the same network, said logical topologies associated with said two protection protocols may overlap.

It should further be noted that the step of creating the loop-free topologies can be executed by simultaneously or successively launching (applying) the two protocols in the network. In the case of simultaneous launching, the loop-free topologies created by the two different protocols may be then respectively maintained by these protocols. However, some of the topologies built by one protocol may be “passed” (immediately or later) to protection by the other protocol.

If the launching is simultaneous or the time period between the launch of a first and a second protocol is relatively short—say, during the network deployment process—the proposed method will reflect deployment of a hybrid network, which will be able to immediately (from day one) provide concurrent protection of different services by two different protocols. If the time period is rather long, i.e. launching of the second protocol is performed into an existing Ethernet network where one of the two protocols is already active—the proposed method will successfully describe a process of upgrading the existing network, with migration of some of the communication services (which were previously protected by one protocol) to protection by the other protocol. The protocol applied later may either create its own topologies for such services, or “occupy” the topologies previously used by these services.

At least one of the protocols should preferably be a multi-instance one, for creating more than one loop-free logical topology in the network. However, say, an RP (or ERP) protocol and a per-VLAN STP protocol can be concurrently utilized in one network according to the invention; though each of them creates a single loop-free topology, VLANs can be distributed between them according to a criterion selected by the operator.

In the preferred version of the method, suitable for the contemporary practice, one of the two protocols is an MST-type protocol such as MSTP, and the other is an RP-type protocol, such as G.8032. Signaling messages, based on which the protocols operate, are bridge protocol data units (BPDUs) which have slightly different names in the two mentioned protocols.

The Ethernet network of interest may be a mesh network, a ring-like network, it may form part of a larger communication network. The version of the method, where the network is first divided to a plurality of MST instances (by firstly initiating MSTP protocol), can be applied to any type of the Ethernet network, but preferably to such being a mesh network where a ring portion can be defined. The RP-type protocol can be then applied to the MST instances covering the ring portion.

If the Ethernet network comprises just a ring-like network, the method can start without preliminarily applying MSTP protocol to the network nodes. When we have a real ring topology of nodes, the G.8032 protocol can be deployed first on the ring, and then MSTP can be selectively deployed to create separate additional MST instances for the services which do not require fast restoration but rather require load balancing.

Therefore, in the proposed invention, at least one of the instances finally maintained by MSTP protocol can be built not by its “native” MSTP protocol, but rather by G.8032 protocol (and vice versa). The recently known version of G.8032 is able to create a loop-free topology/instance on a ring(s), all service VLANs are assigned to this instance at the first stage, and then, at the second stage, some of the VLANs may be picked from that single instance and distributed between additional instances created by MSTP protocol.

In other words, there is no dependency in deployment of the two protocols. All telecommunication services could be started as MSTP-protected and then be partially migrated to protection by G.8032, and vice versa.

The mentioned at least two different groups of telecommunication services are, for example, a) services requiring fast restoration, and b) services preferably requiring load or bandwidth balancing. Some telecom services, handled in the network, may remain not grouped.

The method also comprises ensuring that at least some nodes of the Ethernet network are adapted to selectively apply one or another of the two protection protocols to a specific telecommunication service handled by a node depending on the group to which said specific service belongs (is grouped). The Ethernet nodes of the network may be all provided with the mentioned capability, however, some regular Ethernet nodes may also exist in the mentioned network.

In view of the above, the method can be implemented:

by ensuring that at least in some Ethernet nodes of the network, ports are adapted to selectively apply either a Multiple Spanning Trees (MST)-type protocol or a Ring Protection (RP)-type protocol with respect to a specific telecommunication service,

and by applying at any of said ports:

the RP-type protocol to the telecommunication services preferably requiring fast restoration,

the MST-type protocol to the telecommunication services preferably requiring bandwidth (BW) balancing.

Actually, the new method proposes co-existence of different loop avoiding traffic protection protocols in one and the same Ethernet network and even at one and the same node and at one and the same port, for serving different groups of telecommunication services.

By now, such coexistence has been considered impossible. First of all, the Inventor has recognized that it is possible, brings advantages and can be reached by reasonable technical means.

The Inventor has further recognized that the desired coexistence (concurrent utilizing) of different protection protocols becomes technically possible if:

the network is divided into at least two loop-free logical topologies (instances) respectively assigned to two different groups of telecommunication services and to the two different protection protocols,

a node of the network is adapted to selectively apply at its ports one or another of the two different protocols, depending on the group of the telecommunication service being handled, and

any specific port of any specific Ethernet node is adapted to independently forward and process signaling messages of any one of said two protocols; even if blocked for traffic of a specific telecommunication service according to a specific instance assigned to the specific telecommunication service, a port safely forwards signaling messages of any one of said two protection protocols and independently processes signaling messages of one of the protocols.

Traffic data packets of different services (presented by different service VLANs) are forwarded according to their assignment to the instances. Each port has a VLAN table where the port's forwarding state is defined. In case of a protection event (i.e., in case of any fault in a link/node being part of one or more STP instances), each of the protection protocols performs its independent convergence process, i.e. rebuilds its faulty instance for the services (service VLANs) assigned to the instance.

The invention also provides an Ethernet network where at least two different loop avoiding traffic protection protocols are applicable concurrently to different logical topologies of the network and to different telecommunication services;

the network being such that, at least at one of its nodes, said at least two different loop avoiding traffic protection protocols are applicable concurrently to different telecommunication services handled at one and the same node, while to a specific telecommunication service handled at said node, applicable is only a specific one from said two protocols, depending on said specific service (say, a specific protocol is selected as appropriately protecting that specific service).

In the above network, the two different protocols can be concurrently applicable even to different telecommunication services handled at one and the same port, while a specific protocol from said two protocols is applicable to a specific telecommunication service handled at said port, depending on said specific service.

More specifically, the Ethernet network should be capable of concurrently utilizing said two protocols for handling in the network at least two different groups of telecommunication services grouped according to protection criteria, wherein each node of said at least one nodes is adapted to selectively apply, at a specific port thereof, one or another of the two protocols to the telecommunication service handled at said port, depending on the group to which said service belongs.

Still more specifically, the two different groups of the telecommunication services are being respectively carried via different loop-free topologies created in the network and maintained by said two protocols.

The Ethernet network should be understood as at least a section of a larger Ethernet network being a mesh network or a ring-like network. Preferably, the Ethernet network is a metro network or a Provider Bridge (PB) network. The two protocols are preferably an MST-type protocol and an RP-type protocol.

Preferably, all nodes of the Ethernet network are the nodes provided with the described capability (“double-protocol” nodes). Nodes not provided with the above-described function cannot be part of a ring topology, but can be present in a mesh topology of the discussed Ethernet network. If such nodes are present in the mesh topology, they may receive MST-protected telecommunication services but definitely cannot receive the RP-protected services.)

Further preferably, all ports of the “double protocol” nodes have the “double-protocol” capability.

The invention further provides a network node (an Ethernet node) for operating at an Ethernet network, the node being provided with a double-protocol block for concurrently applying two loop avoiding traffic protection protocols to different telecommunication services handled by the node and belonging to one or another kind (or one or another of two different groups), wherein said block being adapted to selectively apply one or another protocol to a telecommunication service being handled at the node, depending on the kind (group) to which said telecommunication service belongs.

The node can be further capable of concurrently applying the two protocols to different telecommunication services handled at one and the same port of the node, and to selectively apply one or another of the two protocols to a telecommunication service handled at said port, depending on the type (or group) to which said telecommunication service belongs.

With the aid of the double-protocol block thereof, the node is preferably adapted to independently forward and process signaling messages of both of said two protocols at any port thereof. Processing of signaling messages of a specific protocol is performed according to that specific protocol.

The mentioned double-protocol block preferably comprises a double-protocol software-hardware stack. Further preferably, the block is capable to concurrently and selectively apply the two protocols, as described above, at all ports of the node.

Preferred implementations of the network and the network node are adapted to the two protocols being an MST-type protocol (such as MSTP) and an RP-type protocol (for example G.8032) and to the two groups of telecommunication services, wherein the first group comprises telecommunication services preferably requiring bandwidth balancing, and the second group—fast restoration.

The network preferably comprises a Management entity for assigning the telecommunication services to instances (i.e., to the network nodes and ports) and for configuring specific double-protocol network nodes (say, by configuring a data base of the mentioned block of each specific node) in order to concurrently and selectively apply the two protocols at ports of said network nodes in the network.

For example, the management entity can be implemented as a Network Management System (NMS) and/or as a Common Line Interface (CLI) of a network element (node). The NMS and/or the CLI may receive instructions from the network operator and provide information for configuring the nodes.

The invention also provides a software product comprising computer implementable instructions and/or data for carrying out the proposed method, stored on an appropriate computer readable storage medium so that the software is capable of enabling operations of said method when used in a management entity and/or in a double-protocol block in an Ethernet network node.

The invention will be explained in further details as the description proceeds.

### BRIEF DESCRIPTION OF THE DRAWINGS

The invention will be further described and illustrated with reference to the non-limiting drawings in which:

FIGS. 1A, 1B schematically illustrate how an Ethernet network, having a simplified ring-like configuration, is divided into a number of loop-free topologies and a how the different topologies are assigned to different loop avoiding protection protocols.

FIG. 2 illustrates a schematic mapping table as a simplified example of assigning a plurality of telecommunication services (service VLANs in an Ethernet network) to three different loop-free topologies.

FIG. 3 schematically illustrates a block-diagram of a double-protocol block of an Ethernet node.

FIG. 4 is a flow chart schematically illustrating how the discrimination and the processing of signaling messages of two different protocols can be performed at a specific node and port.

### DETAILED DESCRIPTION OF THE INVENTION

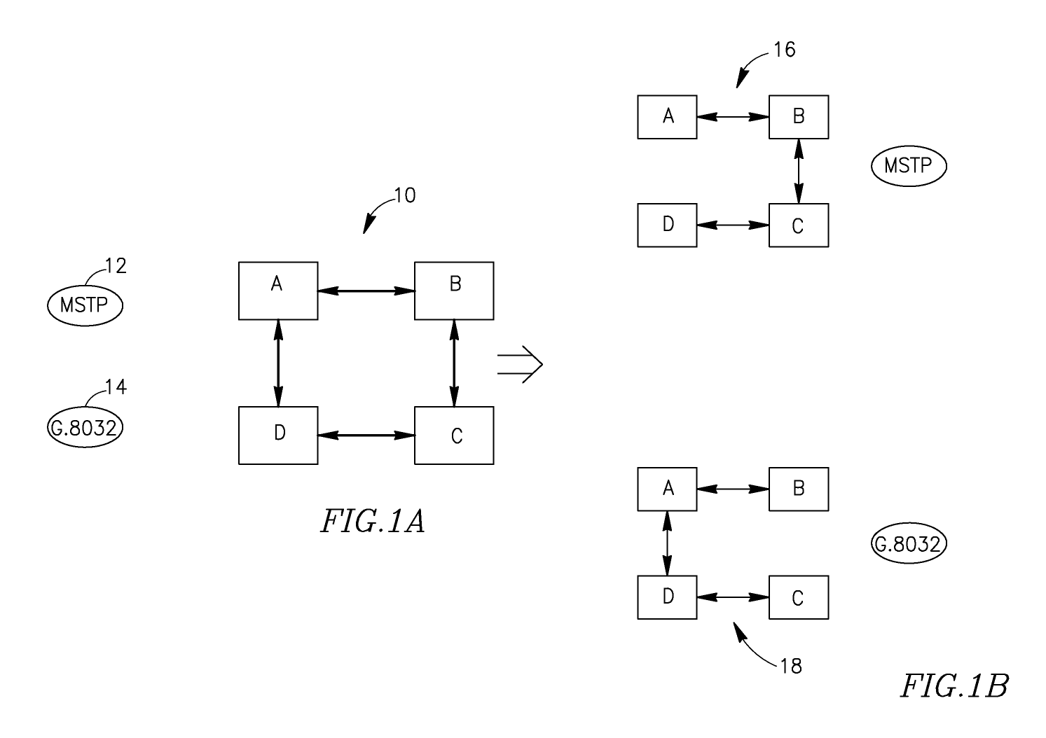

FIG. 1A schematically illustrates a simplified Ethernet network. In this example, it is a ring like network 10 carrying bidirectional traffic between nodes A, B, C, D. The traffic in the network is formed by different communication services, such traffic is concurrently protected by two loop-avoiding protocols 12 and 14. In this example, they are MSTP and G.8032.

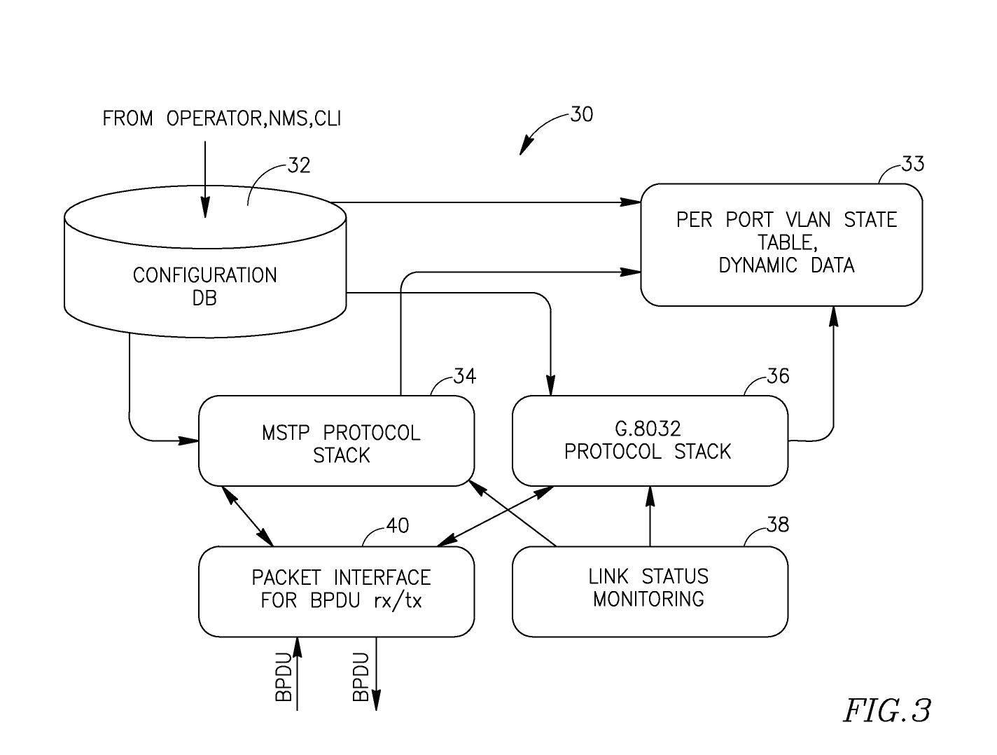

Each node of the ring has a double-protocol block (schematically shown in FIG. 3), comprising two protocol stacks, which selectively apply one or another protocol to specific telecommunication traffic service carried through a specific port. Since a node and even a specific port usually carries more than one service, the node may concurrently apply two traffic protection protocols to different services.

FIG. 1B. For the sake of simplicity, only two exemplary loop-free instances (logical topologies or configurations) 16 and 18 are shown, which can be built on the network 10. For the ring network 10, any of the two above-mentioned traffic protection protocols 12 and 14 may create one or both of the two illustrated loop free topologies 16 and 18. Important is that, according to the invention, the two different instances 16 and 18 are served by the above-mentioned two different protocols. Instance 16 (A-B-C-D) is served by the MSTP protocol, i.e. traffic of the communication services being carried via instance 16 is accompanied by MSTP BPDU messages. In this example, MSTP BPDUs are untagged packets having the destination MAC (01-c0-80-00-00-08).

Instance 18 (B-A-D-C) is served by G.8032 protocol, so traffic of the services carried via instance 18 is accompanied by G.8032 BPDU messages. These messages are also untagged and have a different destination identification, say, MAC (01-19-A7-00-00-01).

Actually, each of the logical topologies can be created and then served by the respective protocol—say, instance 16 by MSTP and instance 18 by G.8032, in any order. However, both of the logical topologies may be first created by applying MSTP to the network and obtaining two MST instances, but may be then maintained by different protocols. Similarly, two logical topologies can be created by first applying G.8032 protocol to the network (which in this case must be a ring-like network, similar to network 10), and then transferring one of the topologies to be maintained by MSTP. When G.8032 creates a logic loop-free topology, the operator defines a Ring Manager node—a node who will block one of its two links. According to the topology 18, it is B or C node. G.8032 explicitly states which link will be active and which will never work if no fault is detected in the network.

When applying MSTP for creating a number of loop-free topologies/instances, the protocol selects a Root Bridge (such as A or D in topology 16), gives priorities (bandwidth costs) to links and starts an iterative search of topologies. The purpose is to find topologies being such that links which have the highest costs in the network are preferably those which are absent in one or more topologies. Since such a link can be used only if the logical topology changes in a case of a fault, the protocol implicitly regulates the load/BW balance in each MST instance and in the whole network. Selection of MSTP topologies can be performed at NMS or CLI

Selection of the instances which will further be maintained by the other protocol, and selection of services to be assigned to different instances is preferably performed by the network operator, though can be formalized and programmed.

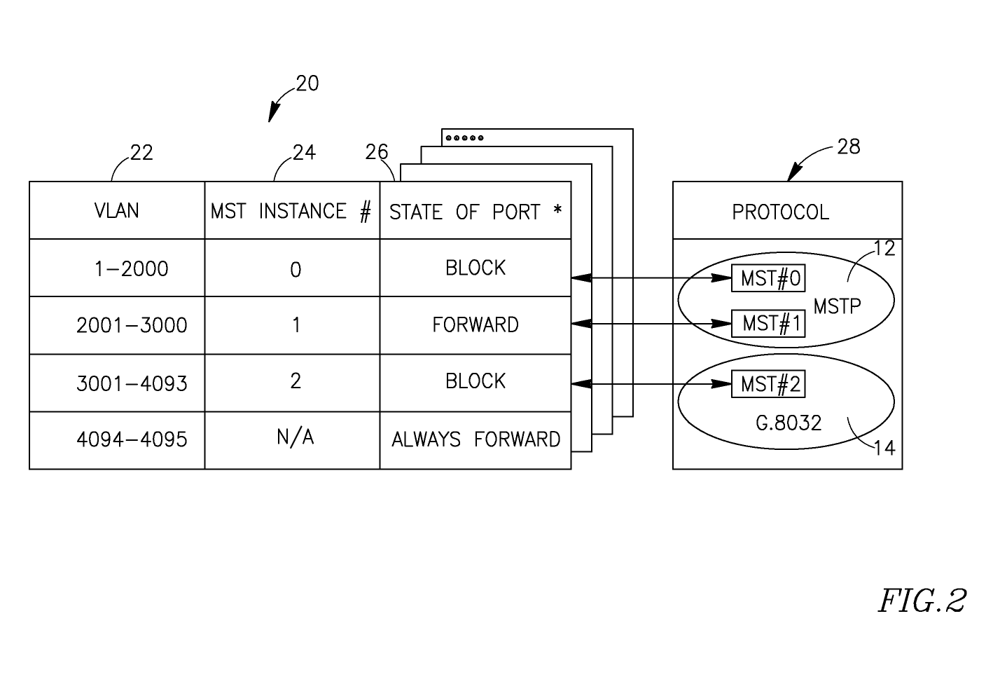

FIG. 2 schematically illustrates a mapping table which is a result of the process of selecting instances, services and assigning them to one another. For a practical case where the two protocols are MST and G.8032 protocols, it comprises:

a) dividing the Ethernet network into a number of instances (loop free logical topologies), for example, as in FIG. 1,
b) defining a plurality of services to be carried through the network, wherein each of said services is associated with a respective service VLAN (S-VLAN) in the network,
c) selecting from the plurality of services one or more services preferably requiring fast restoration in a case of failure in the network (such as voice, video), such services forming a first group of services;
d) selecting from the same plurality one or more services preferably requiring load balancing in a case of a failure, those services will form a second group of services;
e) assigning the plurality of services to the number of instances in such a manner that a specific instance becomes assigned to service(s) (or S-VLANs) belonging to the same group.

Upon performing the division and the assignment, the operator may apply: the G.8032 protocol at the instances assigned to the services of the first group, and MSTP protocol at the instances assigned to the services of the second group.

The first group of services assigned to the instances on which the G.8032 is further run, usually comprise voice and video services, since they do not stand packet loss and therefore require maximally fast restoration in case of a fault. The invention gives to the network operator an ability to protect service VLANs carrying VoIP or Video by the ‘fast’ protection protocol running on the selected instance(s), while at least some of the remaining service VLANs are protected by the instances running the MSTP protocol and thus achieving optimal BW utilization.

Some services (and their S-VLANS) in the network may remain not assigned (N/A) to the instances and left for future use. For example, these services may comprise a control VLAN, a point-to-point non-protected service, etc. reserved, say, for G.8032 control channel(s).

FIG. 2 shows a mapping table 20, which illustrates an example of assignment of communication services (presented as their service VLANs) to loop-free logical topologies (named MST instances). Such a table is provided per port of an Ethernet node. Let table 20 relates to a specific port marked (*).
Column 22 lists sets of telecommunication services presented by their service Virtual Local Access Networks (S-VLANs). Column 24 shows serial numbers of MST instances on which the sets of S-VLANs run.
As can be seen, the first three lines of the table reflect the service VLANs being associated with specific MST instances. However, the fourth line shows that some S-VLANs can be left non-assigned (N/A) to any MST instance. (They can be, for example S-VLANs of services reserved for G.8032 control channel(s), etc.)
Column 26 indicates a state of the specific port (*), for which the table 20 is built, with respect to traffic of S-VLANs of a particular set. For example, our port (*) will block traffic of S-VLANs 1-2000, while traffic of S-VLANs 2001-3000 will be forwarded at the port (*). Multiple columns 26 shown in FIG. 2 indicate that table 20 comprises information for all relevant ports of the node. Table 20 is fulfilled by important information (schematically marked as table 28) clarifying by which protection protocol one or another MST instance (with assigned to it S-VLANs) is supported. As can be seen, MST instances 0 and 1 are maintained/supported by MSTP protocol, while the MST instance 2 is maintained by G.8032 protocol. Tables 20&28 are required for controlling the double-protocol block of the node so as to apply the required protocol out of the two (MSTP and G.8032) to the traffic packets and to the signaling messages (BPDUs) of any specific communication service at port (*) and at other ports of the node.
Traffic data packets of different service VLANs are forwarded at a port according to their assignment to the instances (column 26). As mentioned, each port has a VLAN table where the port's forwarding state is defined. In case of a any fault in one or more instances, each of the protection protocols performs its independent convergence process to rebuild its faulty instance for the service VLANs assigned to the instance.

FIG. 3 schematically illustrates main units of the proposed dual-protocol hardware/software block 30 at the proposed Ethernet node.

The newly proposed technology (network, method, node, software product) are based on coexistence of two protocols, such as MSTP and G.8032, in one and the same network. In practice, it can be achieved by coexistence, at one and the same node, of two different controllable software (SW) units in one block, which are responsible for applying one or another protocol, whichever preferred for the specific telecom traffic service assigned to the specific port. These two different SW units will ensure forwarding of the arriving traffic packets and of accompanying signaling messages (BPDUs) differently, according to the protocol actual for the specific telecom service assigned to the specific port.

The double-protocol block 30 comprises a configuration data base (DB) 32 which receives network configuration information from outside; for example, from the network operator via NMS and/or CLI. That information usually comprises the MST to VLAN mapping table, i.e., columns 22 and 24 of table 20. This information is fulfilled in the DB 32 by column 26, to indicate status of ports in the node. Information from the configuration DB 30 is fed to an MSTP protocol stack 34 and a G.8032 protocol stack 36. The stacks 34 and 36 participate in dividing the network into loop-free logical instances. For example, MSTP stack 34 may inform DB32 about nodes selected to be root nodes in the network. Though, a ring manager node for a G.8032 instance is administratively defined by an operator. Based on the information received from the network operator via DB32, blocks 34 and 36 form the per-port VLAN state table (20) in the DB 32. That information is also fed to unit 33, which will accumulate dynamic data on the links and ports. Unit 33 accumulates information formed at the node, which includes the initial data from the operator+the status per port (table 20) and the dynamic changes introduced due to links' monitoring. Unit 30 is required to control how the traffic (not shown) of different services should be handled (blocked or forwarded) at the node.

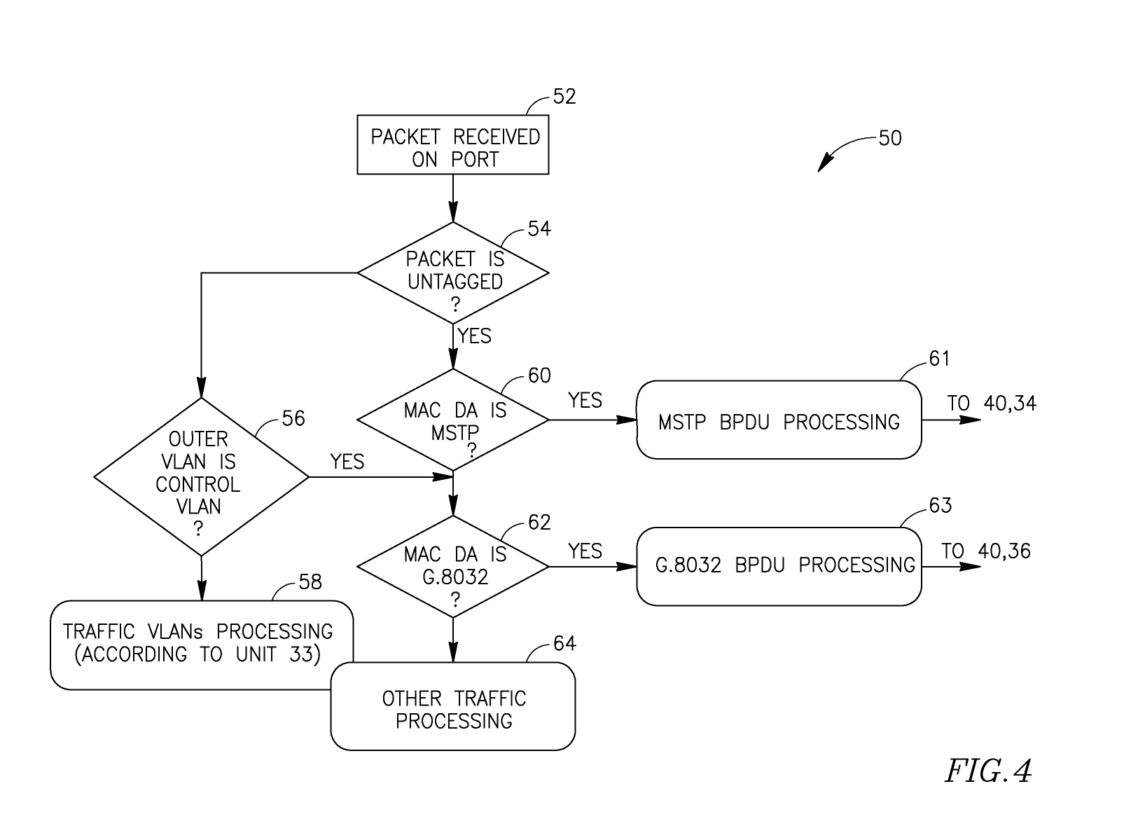

Each node comprises means for link status monitoring (38) which updates both of the protocol stacks 34 and 36 about any changes/faults in the network links. In case of a fault, at least one of the two stacks rebuilds the logical configuration of the network and updates the unit 33. Processing of traffic packets (not shown) is controlled by unit 33.
Packet interface 40 for BPDUs of different protocols is used by the two protocol stacks 34 and 36; the interface 40 handles the BPDUs (transmits, receives, processes according to the required protocol in cooperation with blocks 34 and 36). According to the concept of the invention, a port of the proposed Ethernet node does not block BPDUs of any protocol. Contrary to that, previous technologies could not simultaneously handle BPDUs of more than one protocol at a port.
FIG. 4 explains how BPDU messages of two different protocols are handled at one and the same port. As has been mentioned, BPDU messages of MSTP and G.8032 protocols are forwarded by all physical ports and at each of the ports are independently processed (i.e., orders of the BPDUs are executed) by one of the protocols—either G.8032 or MSTP. Discrimination of BPDUs from traffic packets is usually performed based on the fact that BPDUs are untagged. Further, BPDUs of different protocols have different destination MAC address at the end. A simplified flow chart diagram 50 explains the way of operation of the double-protocol hardware/software block 30 of the Ethernet node. When a packet is received at a specific port (box 52), it is checked whether it is untagged. If the packet is tagged, it either occurs to be a traffic packet (box 58) which will be processed according to instructions of column 26 of table 20, or might be a specific BPDU of a control VLAN of G.8032. If the packet is untagged, it will be checked for its MAC Destination Address and may appear to be either an MSTP BPDU (box 61), or the G.8032 BPDU (box 63). According to one or another, the BPDUs will be processed suitably.
MSTP BPDU messages will be processed at units 40 and 34 shown in FIG. 3. Namely, they are terminated and processed by the MSTP protocol and, if the message is critical (say, there is a fault in a link), the state machine of the MSTP protocol (unit 34) will update the logical topology and thus update column 26 of table 20 in unit 33. G.8032 BPDU messages will be processed at units 40 and 36 of FIG. 3. Forwarding and processing of the G.8032 BPDU messages are performed according to the G.8032 protocol and depending on the type of node (Ring Manager or Regular Node) in the suitable topology. All G.8032 BPDUs will be processed at 40 and 36 and, if a BPDU message occurs critical, the stack 36 will be forced to create a new ring topology and then to update the dynamic data (column 26 of table 20) in unit 33. Other packets, not classified as above, will be processed differently (block 64).

It should be appreciated that other versions of the method and other embodiments of the network and the node can be proposed. Since new versions of the presently used Ethernet traffic protection protocols are definitely being developed, resulting modifications should be considered equivalent to those described in the present invention and should be understood as part of the invention as defined by the claims which follow.

1. A method for protecting different telecommunication services in an Ethernet network using at least two different loop avoiding traffic protection protocols, by concurrently utilizing two of said protocols in one and the same network on different loop free logical topologies of the network, wherein said telecommunication services are preliminarily distributed in such a manner, that the services appropriately protectable by one of the two protocols and the services appropriately protectable by the other of the two protocols are respectively carried via the different loop free logical topologies.

2. The method according to claim 1, comprising steps of:
grouping said services into at least two groups, wherein one group comprises services appropriately protectable by one of the two protocols, and the other group comprises services appropriately protectable by the other of the two protocols,
creating in said network two or more said different loop-free logical topologies;
assigning said services to said topologies so that one topology carries services belonging to one and the same group;
associating said two or more topologies with said two protocols so that each of the protocols is associated with at least one topology, and so that services assigned to a specific topology be appropriately protected by the protocol associated with said specific topology;
providing traffic protection in said network by applying said two protocols, on their respectively associated topologies,
thereby ensuring for each of said two groups of telecommunication services optimal protection in the network.

3. The method according to claim 2, wherein the step of creating loop-free topologies is executed either by simultaneous or by successive applying of the two protocols in the network.

4. The method according to claim 1, wherein one of the two protocols is a Multiple Spanning Trees (MST)-type protocol such as MSTP, and the other one is an RP-type protocol, such as G.8032.

5. The method according to claim 1, wherein said telecommunication services comprise services preferably requiring load balancing, and services preferably requiring fast restoration.

6. The method according to claim 5, comprising
ensuring that at least in some Ethernet nodes of the network, ports are adapted to selectively apply either a Multiple Spanning Trees (MST)-type protocol or a Ring Protection (RP) type protocol to a specific telecommunication service, and, at any of said ports
applying the RP-type protocol to the telecommunication services preferably requiring fast restoration, while
applying the MST-type protocol to the telecommunication services preferably requiring bandwidth (BW) balancing.

7. A method for protecting two different groups of different telecommunication services in one Ethernet network by two different loop avoiding protection protocols, comprising:
dividing the network into at least two loop-free logical topologies respectively assigned to the two different groups of telecommunication services and to the two different protection protocols,
selectively applying, at ports of an Ethernet node in the network, one or another of the two different protocols, depending on the group of the telecommunication service being handled, and
ensuring that ports of an Ethernet node in the network are adapted to independently forward and process signaling messages of any one of said two protocols.

8. An Ethernet network, wherein two different loop avoiding traffic protection protocols are applicable concurrently to different logical topologies of the network and to different telecommunication services handled at one and the same network node, while to a specific telecommunication service being handled at said node, applicable is a specific one from said two protocols, depending on said specific service.

9. A node for operating at an Ethernet network, being provided with a double-protocol block for concurrently applying two loop avoiding traffic protection protocols to different telecommunication services handled by the node and belonging to one or another of two different groups, wherein said block being adapted to selectively apply one or another protocol to a telecommunication service being handled at the node, depending on the group to which said telecommunication service belongs.

10. The node according to claim 9, wherein said double-protocol block is further capable of concurrently applying the two protocols to different telecommunication services handled at one and the same port of the node, and of selectively applying one or another of the two protocols to a telecommunication service handled at said port, depending on the group to which said telecommunication service belongs.

11. The node according to claim 9, adapted to independently forward and process signaling messages of both of said two protocols at any port thereof.

12. A software product comprising computer implementable instructions and/or data for carrying out the method according to claim 1, stored on an appropriate computer readable storage medium so that the software is capable of enabling operations of said method when used in a management entity and/or in an Ethernet network node.
